(19) United States
(12) Patent Application Publication
(10) Pub. No.: US 2011/0305900 A1
(43) Pub. Date: Dec. 15, 2011

(54) COMPOSITION CONTAINING POLYPROPYLENE AND/OR A PROPYLENE COPOLYMER OBTAINED FROM RENEWABLE MATERIALS, AND USES THEREOF

(75) Inventors: Samuel Devisme, Rouen (FR); Fabrice R. Chop, Bala Cynwyd, PA (US); Jean-Laurent Pradel, Boisney (FR); Guillaume Le, Colombelles (FR); Thomas Roussel, Lyon (FR); Jean-Luc Dubois, Millery (FR)

(73) Assignee: ARKEMA FRANCE, Colombes (FR)

(21) Appl. No.: 13/131,347

(22) PCT Filed: Dec. 2, 2009
(86) PCT No.: PCT/FR09/52365

§ 371 Date: Aug. 30, 2011

(30) Foreign Application Priority Data
Dec. 3, 2008 (FR) 0858244

(51) Int. Cl. B32B 7/12; B32B 27/08; C09J 151/06; B32B 15/08; C08F 255/02; C08L 51/06

(52) U.S. Cl. 428/344; 525/286; 525/301; 525/309; 525/71; 525/78; 525/80; 428/355 AC; 428/457; 428/474.4; 428/500

(57) ABSTRACT

The present application relates to a method for manufacturing a propylene polymer, including: a) fermenting and optionally purifying first renewable materials to produce an alcohol or an alcohol mixture, the alcohol or alcohol mixture including at least isopropanol and/or at least a mixture of ethanol and 1-butanol; b) dehydrating the resulting alcohol or the alcohol mixture to produce an alkene or alkene mixture in a first series of reactors, the alkene or alkene mixture containing at least propylene; c) polymerizing the propylene in a second reactor, optionally in the presence of a comonomer, so as to produce a propylene polymer; d) isolating the propylene polymer obtained in step c); and e) grafting the propylene polymer obtained from step d). The invention also relates to the grafted propylene polymer capable of being obtained by the method, to the compositions containing the polymer, as well as to the uses of the polymer.

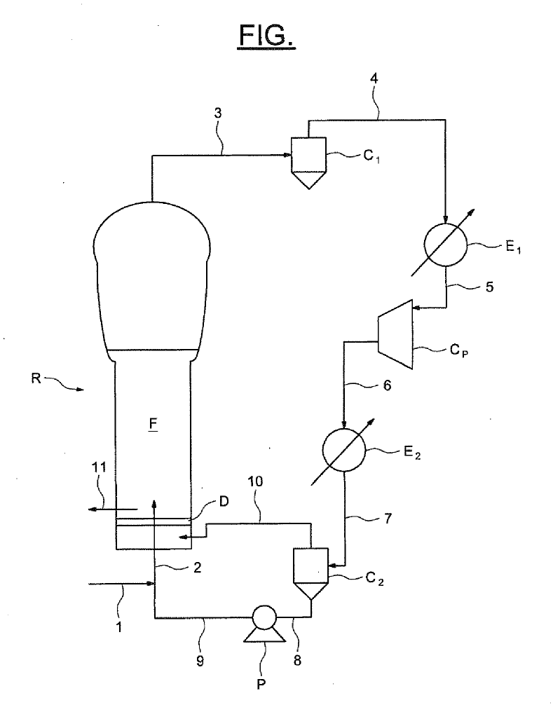

### FIELD OF THE INVENTION

The present invention relates to a process for manufacturing a homopolymer or copolymer of propylene from renewable materials and to the applications of these polymers.

In particular, the invention relates to a process for manufacturing a homopolymer or copolymer of propylene from propylene obtained from at least one alcohol resulting from the fermentation of renewable raw materials; preferably the renewable raw materials are plant materials.

### PRIOR ART

Propylene is among the most commonly manufactured and used products of the petrochemical industry. Polymers based on propylene are mainly used in the textile industry, furniture especially garden furniture, packaging (rigid or flexible) and motor vehicle construction.

Propylene is incorporated into the manufacture of many polymers including polypropylene (homopolymer), random copolymer polypropylene which is in general produced with ethylene as comonomer and block copolymer polypropylene which is a rubber of ethylene and propylene produced in several steps.

Conventionally, propylene is obtained by catalytic or thermal cracking of oil fractions.

Three forms of polypropylenes exist: isotactic, syndiotactic and atactic, which differ from one another by the position of the methyl group on the polymer chain. Industrially, the isotactic polymer constitutes the desired form whereas it is sought to avoid obtaining atactic polypropylene in the final product.

Atactic polypropylene may be eliminated by centrifugation; much research has also been carried out in order to directly obtain polypropylene that does not contain atactic polypropylene.

One particularly advantageous polypropylene is grafted polypropylene; this polypropylene can be used in many applications.

One of the problems posed by the processes for the synthesis of propylene-based polymers of the prior art is that they are produced from raw materials of non-renewable fossil (oil) origin. However, oil resources are limited; the extraction of oil makes it necessary to bore increasingly deeper under ever more difficult technical conditions requiring sophisticated equipment and the use of processes that are ever more costly in terms of energy. These constraints have a direct consequence on the cost of manufacturing propylene and therefore its homopolymers and copolymers.

In order to limit the consumption of oil, recycled materials or processes for manufacturing material by recycling polyolefins have been described in documents JP 09 095567 A, EP 1 219 675 or KR 20030022426. However, recycling involves a conversion of the recycled polyolefins above their melting points, which results in their degradation. Thus, at the end of several recycling operations, the material is completely degraded and has lost its initial properties. Furthermore, the raw materials still result from raw materials of fossil origin.

In application WO 2008/067627, a process is described for manufacturing polyolefin from olefins comprising from 2 to 4 carbon atoms from renewable resources. In particular, the step of synthesis of olefins for the manufacture of this polyolefin comprises a biomass gasification step. This step is carried out at very high temperature (generally between 1100° C. and 1300° C.), which involves high energy consumptions for this step. If this energy is of fossil origin, it then contributes to the release of greenhouse gases (including CO₂).

### DESCRIPTION OF THE INVENTION

Advantageously and surprisingly, the inventors of the present application have employed a process for the industrial manufacture of propylene-based polymers starting from renewable raw materials.

The process according to the invention makes it possible to at least partly dispense with raw materials of fossil origin and to replace them with renewable raw materials.

Moreover, the propylene-based polymers obtained following the process according to the invention are of such a quality that they can be used in all the applications in which it is known to use these polymers, including in the most demanding applications.

One subject of the invention is a propylene polymer in which at least one portion of the carbon atoms of the propylene is of renewable origin; this portion of renewable origin may be determined according to the standard ASTM D 6866-06; this polymer is in particular capable of being obtained by the process described below.

In particular, one subject of the present invention is the grafted propylene polymer in which at least one portion of the carbon atoms is of renewable origin, that is to say that the carbon atoms of renewable origin may be determined according to the standard ASTM D 6866-06. Said grafted propylene polymer is capable of being obtained by the process according to the invention.

Another subject of the invention is a process for manufacturing a propylene polymer comprising the following steps:
a. fermentation of renewable raw materials, and optionally purification, in order to produce an alcohol or a mixture of alcohols, said alcohol or mixture of alcohols comprising at least isopropanol and/or at least one mixture of ethanol and 1-butanol;
b. dehydration of the alcohol or of the mixture of alcohols obtained with a view to producing, in at least one first reactor, an alkene or a mixture of alkenes, said alkene or mixture of alkenes comprising at least propylene and, optionally purification of the mixture of alkenes in order to obtain propylene;
c. polymerization, in at least one second reactor, of the propylene, optionally in the presence of a comonomer, in order to produce a propylene polymer;
d. isolation of the propylene polymer obtained at the end of step c);
e. preferably, grafting of the propylene polymer obtained at the end of step d).

Another subject of the invention is the compositions comprising at least one homopolymer or copolymer of propylene, preferably grafted, and also the uses thereof.

Other subject matters, aspects and features of the invention will appear on reading the following description.

Step a) of the process for manufacturing propylene polymers comprises the fermentation of renewable raw materials in order to produce at least one alcohol. When an alcohol is produced, it is isopropanol. When a mixture of alcohols is produced, this mixture comprises at least isopropanol and/or at least ethanol and/or 1-butanol.

A renewable raw material is a natural resource, for example animal or plant, the stock of which can be reformed over a short period on the human scale. In particular, it is necessary for this stock to be able to be renewed as quickly as it is consumed. For example, plant materials exhibit the advantage of being able to be cultivated without their consumption resulting in an apparent reduction in natural resources.

Unlike the materials resulting from fossil materials, renewable raw materials comprise ¹⁴C. All the samples of carbon drawn from living organisms (animals or plants) are in fact a mixture of 3 isotopes: ¹²C (representing approximately 98.892%), ¹³C (approximately 1.108%) and ¹⁴C (traces: 1.2×10⁻¹⁰%). The ¹⁴C/¹²C ratio of living tissues is identical to that of the atmosphere. In the environment, ¹⁴C exists in two predominant forms: in the form of carbon dioxide gas (CO₂) and in organic form, that is to say in the form of carbon incorporated in organic molecules.

In a living organism, the ¹⁴C/¹²C ratio is kept constant by metabolism because the carbon is continually exchanged with the external environment. As the proportion of ¹⁴C in the atmosphere is constant, it is the same in the organism as long as it is alive, since it absorbs this ¹⁴C in the same way as the ambient ¹²C. The mean ¹⁴C/¹²C ratio is equal to 1.2×10⁻¹².

¹²C is stable, that is to say that the number of ¹²C atoms in a given sample is constant over time. ¹⁴C is radioactive; the number of ¹⁴C atoms in a sample decreases over time (t), its half life being equal to 5730 years.

The ¹⁴C content is substantially constant from the extraction of the renewable raw materials up to the manufacture of the polypropylene polymer according to the invention and even up to the end of the lifetime of the object manufactured of said polymer.

Consequently, the presence of ¹⁴C in a material, whatever the amount thereof, is an indication with regard to the origin of the molecules constituting it, namely whether they originate from renewable raw materials and not from fossil materials.

The amount of ¹⁴C in a material can be determined by one of the methods described in the standard ASTM D 6866-06 (Standard Test Methods for Determining the Biobased Content of Natural Range Materials Using Radiocarbon and Isotope Ratio Mass Spectrometry Analysis).

This standard comprises three methods of measuring the organic carbon resulting from renewable raw materials, referred to as “biobased carbon”. The proportions indicated for the propylene polymer of the invention are preferably measured according to the mass spectrometry method or the liquid scintillation spectrometry method described in this standard and very preferably by mass spectrometry.

These measurement methods evaluate the ratio of the ¹⁴C/¹²C isotopes in the sample and compare it with a ratio of the ¹⁴ C/¹² isotopes in a material of biological origin giving the 100% standard, in order to measure the percentage of organic carbon in the sample.

Preferably, the propylene polymer according to the invention comprises an amount of carbon resulting from renewable raw materials of greater than 20%, preferably of greater than 50% by weight, relative to the total weight of carbon of the polymer.

In other words, the polymer can comprise at least 0.24×10⁻¹⁰% by weight of ¹⁴C and preferably at least 0.6×10⁻¹⁰% by weight of ¹⁴C.

Advantageously, the amount of carbon resulting from renewable raw materials is greater than 75%, preferably equal to 100% by weight, relative to the total weight of carbon of the polymer.

More preferably still, the propylene polymer according to the invention is grafted by at least one grafting monomer chosen from unsaturated carboxylic acids and their functional derivatives, unsaturated dicarboxylic acids having 4 to 10 carbon atoms and their functional derivatives, C₁-C₈ alkyl esters, glycidyl ester derivatives of unsaturated carboxylic acids, or metal salts of unsaturated carboxylic acids, and the propylene polymer comprises an amount of carbon resulting from renewable raw materials of greater than 20%, preferably greater than 50% by weight, relative to the total weight of carbon of the propylene polymer.

Advantageously, the amount of grafting monomer represents at most 10%, preferably from 1000 ppm to 10% by weight, relative to the total weight of the polymer.

Use may be made, as renewable raw materials, of plant materials, materials of animal origin or materials of plant or animal origin resulting from recovered materials (recycled materials).

Within the meaning of the invention, the materials of plant origin contain at least sugars and/or polysaccharides such as starch, cellulose or hemicellulose.

The plant materials containing sugars are essentially sugar cane and sugar beet; mention may also be made of maple, date palm, sugar palm, sorghum or American agave; the plant materials containing starches are essentially cereals and legumes, such as corn, wheat, barley, sorghum, soft wheat, rice, potato, cassava or sweet potato, or algae.

Use may also be made, as renewable raw materials, of cellulose or hemicellulose, which can be converted to sugar-comprising materials in the presence of appropriate microorganisms. These renewable materials include straw, wood or paper, which can advantageously originate from recovered materials.

Mention may in particular be made, among materials resulting from recovered materials, of plant or organic waste comprising sugars and/or polysaccharides.

Preferably, the renewable raw materials are plant materials.

In the case of polysaccharides, the plant material used is generally in hydrolyzed form before the fermentation step. This preliminary hydrolysis thus enables, for example, the saccharification of starch in order to convert it to glucose, or the conversion of sucrose to glucose.

The lists presented above are not limiting.

The fermentation of the renewable materials takes place in the presence of one or more appropriate microorganisms; this microorganism may optionally have been modified naturally, by a chemical or physical stress, or genetically; the term used is then mutant.

Advantageously, the microorganism used is Clostridium beijerinckii or one of its mutants preferably immobilized on a support of the polymer fiber or calcium type. This fermentation makes it possible to obtain a mixture of alcohols comprising ethanol, isopropanol and 1-butanol. The alcohols obtained may be continuously extracted using a pervaporation membrane; one advantage of the use of this type of membrane is enabling a better preservation of the microorganisms, since these are destroyed when their concentration becomes too high.

Other microorganisms which may be used are Clostridium aurantibutyricum or Clostridium butylicum and also their mutants. The fermentation of these raw materials essentially leads to the production of isopropanol and/or butanols optionally with acetone.

According to a first variant, the alcohol obtained is essentially isopropanol.

The fermentation step is advantageously followed by a purification step, for example a distillation intended to separate the isopropanol from the other alcohols.

According to this first variant, the dehydration of the isopropanol is carried out in step b) in order to produce, in a first reactor, at least propylene or a mixture of alkenes comprising propylene, the secondary product of the dehydration being water.

Generally, the dehydration is carried out in the presence of oxygen and water using a catalyst based on α-alumina such as the catalyst sold by EUROSUPPORT under the trade name ESM 110® (undoped trilobe alumina containing little—around 0.04%—residual Na₂O).

The operating conditions for the dehydration form part of the general knowledge of a person skilled in the art; by way of indication, the dehydration is generally carried out at a temperature of around 400° C.

One advantage of this process according to the invention is its energy saving: the fermentation and dehydration steps of the process according to the invention are carried out at relatively low temperatures, below 500° C., preferably below 400° C.; in comparison the step of cracking or steam cracking oil to give propylene is carried out at a temperature of around 800° C.

This energy saving is also accompanied by a reduction in the amount of CO₂ emitted into the atmosphere.

According to a second variant, which may be carried out following a fermentation by means of Clostridium beijerinckii or one of its mutants, a mixture of alcohols is obtained comprising at least ethanol and 1-butanol.

Advantageously, the fermentation step is followed by a purification step, for example a distillation intended to separate the ethanol and 1-butanol from the other alcohols.

According to this second variant, step b) is carried out using a series of reactors:
in a first part of the series of reactors (located at the inlet of the series of reactors in the direction of the flow of the fluids) the dehydration of ethanol and 1-butanol is carried out with a view to producing at least ethylene and 1-butene, this dehydration being carried out under the same conditions as the dehydration of isopropanol described above;
in a second part of this first series of reactors (situated in the intermediate part of the series of reactors) a hydroisomerization reaction of 1-butene to give 2-butene is carried out;
in a third part of this first series of reactors (situated at the outlet of the series of reactors in the direction of the flow of the fluids) the metathesis of ethylene and 2-butene is carried out in order to form propylene.

The details of the hydroisomerization and metathesis reactions are for example mentioned in patent application FR 2 880 018.

The hydroisomerization reaction of 1-butene to give 2-butene is generally carried out using a catalytic composition comprising a compound of a group VIII transition metal and more particularly palladium or nickel. The catalytic composition may also comprise a quaternary ammonium and/or phosphonium salt which makes it possible to carry out the reaction at a relatively low temperature, in a closed or semi-closed system or continuously.

The metathesis reaction is carried out by passage of the reactants in contact with a catalyst bed; the metathesis is in general carried out continuously, and comprises a reaction phase and a regeneration phase. The catalysts used contain rhenium oxide on alumina or a compound derived from alumina such as for example a silica-alumina or a boron oxide-alumina.

Preferably, the microorganism used is Clostridium beijerinckii or one of its mutants, this microorganism may indeed be used in order to carry out the first variant and the second variant, and also the process may be carried out using isopropanol and/or the combination of ethanol and 1-butanol.

The optional purification steps (purification of alcohol(s) obtained in step a), purification of alkene(s) obtained in step b)) are advantageously carried out via absorption on conventional filters such as molecular sieves, zeolites, carbon black, etc.

Advantageously, at least one purification step is carried out during step a) and/or step b) in order to obtain propylene having a sufficient degree of purity to carry out a polymerization or a copolymerization. Obtaining propylene having a degree of purity of greater than 85% by weight, preferably greater than 95% by weight, preferably greater than 99% by weight and very preferably greater than 99.9% by weight will be preferred.

The main impurities present in the propylene resulting from these dehydration operations are acetone, diisopropyl ether, acetaldehyde, 1-propanol and hydrogen.

Advantageously, the propylene is purified, that is to say that the acetone, diisopropyl ether, acetaldehyde, 1-propanol and hydrogen should be removed in order to be able to easily polymerize in step c).

The hydrogen, which has a boiling point far below that of the propylene, may be isolated by compressing the gas, then cooling it slightly, for example to 19 bar and −33° C.

The propylene, acetone, diisopropyl ether, acetaldehyde and 1-propanol may be separated by carrying out one or more low-temperature distillations.

The atmospheric pressure boiling points of these compounds are the following:

| | boiling point |
|---|---|
| compound | (° C.) |
| propylene | −47.7 |
| acetaldehyde | 20.8 |
| acetone | 56 |
| diisopropyl ether | 68 |
| 1-propanol | 97 |

The propylene, acetone, diisopropyl ether, acetaldehyde and 1-propanol are cooled at atmospheric pressure to around −50° C., preferably −47.7° C., then distilled in order to extract the propylene. This distillation may optionally be carried out under reduced pressure in order to be able to extract the propylene at a higher temperature.

Another advantage of the process according to the present invention relates to the impurities. The impurities present in the propylene resulting from the dehydration of the alcohols are completely different from those present in the propylene resulting from cracking or steam cracking. In particular, the impurities present in the propylene resulting from cracking or steam cracking include methylacetylene and propadiene.

With the process according to the present invention, methylacetylene and propadiene are also obtained but these compounds are then present in substantially lower amounts. This difference makes it possible to limit the risks linked to the highly reactive nature of methylacetylene and also to limit the secondary oligomerization reactions.

Another advantage is that the process according to the invention may be carried out in production units located on the site of production of the raw materials. Moreover, the size of the production units for the process according to the invention is much smaller than the size of a refinery: specifically, refineries are large installations which are generally located far from the centers for producing the raw materials and which are supplied via pipelines.

All these differences contribute to making the process according to the invention more economical (saving in equipment and saving in energy, which is also accompanied by a reduction in the amount of CO₂ emitted to the atmosphere) than the conventional processes for obtaining propylene.

There are essentially two types of polymerization processes for producing propylene polymers: processes in the liquid phase in particular in suspension and processes in the gas phase. Moreover, these processes may be combined, for example one or two reactors carrying out a polymerization in liquid propylene then one or two reactors carrying out a polymerization in the gas phase.

Included among the suspension polymerization processes, “slurry processes”, are suspension polymerization in a solvent and suspension polymerization in liquid propylene, “bulk or mass processes”.

Over the years, the processes for polymerizing propylene having simplified in particular owing to the improvements made to the catalyst systems, today there are five generations of catalysts. The main improvements have focused on the improvement in the yield and in the stereospecificity. New catalysts have also made it possible to avoid the steps of extracting atactic polypropylene and of extracting catalytic residues.

Today, use is essentially made of 4th and 5th generation catalysts (Ziegler-Natta catalyst), and also “metallocene” catalysts.

The 4th generation catalysts consist of phthalate/silicon donors and a spherical support which is used for a fluid monomer in a homopolymer reactor; the 5th generation catalysts are based, for example, on diether and succinate donor technology.

“Metallocene” catalysts are single-site catalysts. They are essentially ZrCl₂ catalysts supported on silica and generally used in combination with a cocatalyst such as methylaluminoxane (MAO). These catalysts may be used in combination with Ziegler-Natta catalysts.

Suspension polymerization is conventionally carried out using an organic hydrocarbon (generally hexane) that allows the extraction of atactic polypropylene and of catalytic residues. The polymer produced in the reactor is insoluble in the hydrocarbon, thus forming a suspension. Drying makes it possible to remove the last traces of solvent remaining on the polymer powder. The temperature is of the order of 50 to 100° C. and the pressure is a few bar.

Suspension polymerization in liquid propylene (bulk polymerization) essentially differs from suspension polymerization in an organic hydrocarbon via the choice of diluent. The main advantage lies in the absence of the separation or purification of the hydrocarbons.

Suspension polymerization in liquid propylene may be carried out in a bubbling stirred reactor or in a toric loop reactor.

In the bubbling stirred reactor, the reactor pressure ranges from 2.5 to 3.5 MPa, which corresponds to temperatures of 65° C. to 75° C.

In the toric loop reactor, the temperature ranges from 60° C. to 80° C., for a pressure ranging from 3.5 to 4 MPa.

The gas phase polymerization may be carried out in a mechanically stirred bed (with a rising or horizontal stream) or in a fluidized bed, the polymerization takes place between 50 and 105° C. at pressures from 3 to 5 MPa.

All these processes are suitable for the production of polypropylenes (homopolymer, random copolymer or block copolymer).

In the case where the polypropylene is a random or block copolymer, the amount by weight of propylene relative to the total weight of the copolymer is advantageously greater than 10%, preferably greater than 50%, very preferably greater than 90%.

The polypropylenes advantageously have a melting point within a range extending from 140 to 190° C.

Preferably, the polypropylene (homopolymer or copolymer will be obtained using a gas phase polymerization in a fluidized bed.

The block copolymer polypropylene is obtained in at least two steps, each step being carried out with a specific catalyst.

By way of example, mention will be made of the following documents.

U.S. Pat. No. 5,449,738 describes a process for producing ethylene/propylene block copolymers in the gas phase comprising:
a first step of polymerization of propylene or of a mixture of ethylene and propylene carried out using one or more reactors equipped with a catalyst system essentially consisting of:
   (A) a solid catalyst containing magnesium, titanium and a halogen;
   (B) an organoaluminum compound; and
   (C) a silicon compound of formula R¹R²Si(OR³)₂ in which R¹ is a C₅-C₂₀ alicyclic hydrocarbon, R² and R³, independently of one another, being C₁-C₂₀ hydrocarbon-based groups;
a second step of the polymerization of a mixture of ethylene and propylene in the presence of the polymerization product obtained at the end of the first step and of the addition of a second silicon compound (D) of formula R⁴R⁵ₐSi(OR⁶)₃₋ₐ in which R⁴ is a C₆-C₂₀ aromatic hydrocarbon, R⁵ is a C₁-C₂₀ hydrocarbon-based group or a C₆-C₂₀ aromatic hydrocarbon, R⁶ is a C₁-C₂₀ hydrocarbon-based group and a is equal to 0, 1 or 2.

U.S. Pat. No. 5,473,021 describes a process for producing ethylene/propylene block copolymers which may be carried out in the gas phase or in the liquid phase in suspension preferably in an inert solvent. This process comprises:
a first step similar to the first step carried out in the process described in U.S. Pat. No. 5,449,738; and
a second step that consists in bringing into contact a mixture of ethylene and propylene in the presence of the polymerization product obtained at the end of the first step and in the presence of the compounds (A), (B), and (C) described in U.S. Pat. No. 5,449,738 and of a silicon compound (D′) of formula R⁴ₐSi(OR⁵)₄₋ₐ in which R⁴ and R⁵, independently of one another, are C₁-C₂₀ hydrocarbon-based groups and a is equal to 0, 1, 2 or 3.

U.S. Pat. No. 6,117,946 describes a method of producing a copolymer of propylene, of 1-butene and optionally of ethylene using a Ziegler-Natta catalyst in the gas phase, in the absence of an inert solvent. According to this process, a first step is carried out in order to produce an ethylene/propylene/1-butene copolymer or a propylene/1-butene copolymer comprising at most 3% by weight of ethylene and from 3 to 25% by weight of 1-butene, the yield of the polymerization during the first step being between 40% and 85% relative to the total yield of the polymerization and a second step of polymerization of propylene, 1-butene and optionally ethylene is then carried out in the presence of the polymer obtained in the first step containing catalyst in order to produce an ethylene/propylene/1-butene copolymer or a propylene/1-butene copolymer comprising at most a 17% by weight of ethylene and from 3 to 35% by weight of 1-butene, the yield of the polymerization during the second step being between 15% and 60% relative to the total yield of the polymerization.

As block polymer, mention may be made of ethylene/propylene rubbers.

U.S. Pat. No. 5,342,907 presents a process for manufacturing ethylene/propylene rubbers (EPR, EPDM) in the gas phase using a catalytic system comprising a catalyst precursor which is a vanadium triacetylacetonate optionally deposited on a support, a cocatalyst essentially consisting of (i) an alkylaluminum halide and (ii) optionally a trialkylaluminum, and an activator which is a chlorinated ester.

With the monomers and the catalyst, a transfer agent may optionally be introduced; this transfer agent may be, for example, hydrogen, an alkane such as butane and pentane, an aldehyde such as propionaldehyde and acetaldehyde, a ketone such as acetone and methyl ethyl ketone. By adding this transfer agent, it is possible to limit the molecular weight of the polymer manufactured. The number-average molecular weight of the polymer is generally between 1000 and 100 000 g/mol.

Presented in the sole appended FIGURE is a device that enables the implementation of the fluidized-bed (co)polymerization process according to the invention.

This implementation does not in any case constitute a limitation of the polymerization step of the process according to the present invention.

This implementation is carried out by means of the following device comprising a reactor R, and a circuit for recycling the gases comprising two separators of cyclone type C1 and C2, two heat exchangers E1 and E2, a compressor Cp and a pump P.

The reactor R comprises a distribution plate (or distributor) D which defines a lower zone which is a gas and liquid intake zone and an upper zone F where the fluidized bed is located.

The distributor D is a plate in which holes are made, this distributor is intended to homogenize the throughput of the gases entering the reactor.

According to this implementation, a mixture of propylene and of comonomer (ethylene) is introduced via the duct 1, then via the duct 2 into the reactor where the fluidized-bed polymerization is carried out.

The fluidized bed comprises the catalyst and preformed random copolymer particles, this bed is maintained in a fluidized state using a rising stream of gas originating from the distributor D. The volume of the fluidized bed is kept constant by drawing off the copolymer formed by means of the discharge duct 11.

The copolymerization is an exothermic reaction; the temperature inside the reactor is kept constant by controlling the temperature of the (recycled) gas introduced into the reactor via the duct 10.

The gas comprising the molecules of propylene and of ethylene which have not reacted and optionally a transfer agent (for example hydrogen) exit the reactor and enter into the recycling circuit via the duct 3. This gas is treated in the separator of cyclone type C1 in order to remove the optional fine particles of polymer which may have been entrained. The treated gas is then introduced via the duct 4 into a first heat exchanger E1 where it is cooled.

The gas exits the heat exchanger E1 via the duct 5, enters into a compressor Cp, the fluid comes out via the duct 6.

The fluid is cooled in a second heat exchanger E2 so as to condense the comonomers. The duct 7 conveys the fluid from the exchanger E2 to the separator of cyclone type C2.

The gases are separated from the liquids in the separator of cyclone type C2, the liquids exit the separator of cyclone type C2 via the duct 10 and are introduced into the reactor R; the gases exit the separator of cyclone type C2 via the duct 8, enter into the pump P then are introduced via the duct 9, then via the duct 2, into the reactor.

This propylene/ethylene copolymer was prepared from propylene obtained by carrying out steps a) and b) according to the process of the present application.

The propylene polymer obtained is then isolated. Next the polymer is then transported either to an extruder, or to another reactor where it will undergo another treatment such as, for example, grafting.

Preferably, the isolated propylene polymer is then grafted.

As described subsequently, the grafting of the polypropylene is carried out with at least one grafting monomer chosen from unsaturated carboxylic acids and their functional derivatives, unsaturated dicarboxylic acids having 4 to 10 carbon atoms and their functional derivatives, C₁-C₈ alkyl esters of unsaturated carboxylic acids or glycidyl ester derivatives of unsaturated carboxylic acids, or metal salts of unsaturated carboxylic acids.

The polymer may be grafted with an unsaturated carboxylic acid. It would not be outside the scope of the invention to use a functional derivative of this acid.

Examples of unsaturated carboxylic acids are those having from 2 to 20 carbon atoms, such as acrylic acid, methacrylic acid, maleic acid, fumaric acid and itaconic acid. The functional derivatives of these acids comprise, for example, the anhydrides, the ester derivatives, the amide derivatives, the imide derivatives and the metal salts (such as the alkali metal salts) of the unsaturated carboxylic acids.

Unsaturated dicarboxylic acids having 4 to 10 carbon atoms and their functional derivatives, particularly their anhydrides, are particularly preferred grafting monomers.

These grafting monomers comprise, for example, maleic, fumaric, itaconic, citraconic, allylsuccinic, cyclohex-4-ene-1,2-dicarboxylic, 4-methylcyclohex-4-ene-1,2-dicarboxylic, bicyclo[2.2.1]hept-5-ene-2,3-dicarboxylic or x-methylbicyclo[2.2.1]hept-5-ene-2,3-dicarboxylic acids or maleic, itaconic, citraconic, allylsuccinic, cyclohex-4-ene-1,2-dicarboxylic, 4-methylenecyclohex-4-ene-1,2-dicarboxylic, bicyclo[2.2.1]hept-5-ene-2,3-dicarboxylic and x-methylbicyclo[2.2.1]hept-5-ene-2,2-dicarboxylic anhydrides.

Examples of other grafting monomers comprise C₁-C₈ alkyl esters of unsaturated carboxylic acids or glycidyl ester derivatives of unsaturated carboxylic acids, such as methyl acrylate, methyl methacrylate, ethyl acrylate, ethyl methacrylate, butyl acrylate, butyl methacrylate, glycidyl acrylate, glycidyl methacrylate, monoethyl maleate, diethyl maleate, monomethyl fumarate, dimethyl fumarate, monomethyl itaconate and diethyl itaconate; amide derivatives of unsaturated carboxylic acids, such as acrylamide, methacrylamide, maleic monoamide, maleic diamide, maleic N-monoethylamide, maleic N,N-diethylamide, maleic N-monobutylamide, maleic N,N-dibutylamide, fumaric monoamide, fumaric diamide, fumaric N-monoethylamide, fumaric N,N-diethylamide, fumaric N-monobutylamide and fumaric N,N-dibutylamide; imide derivatives of unsaturated carboxylic acids, such as maleimide, N-butylmaleimide and N-phenylmaleimide; and metal salts of unsaturated carboxylic acids, such as sodium acrylate, sodium methacrylate, potassium acrylate and potassium methacrylate. Glycidyl methacrylate is preferred. More preferably still, maleic anhydride is preferred.

According to one particular variant, use may be made of maleic anhydride comprising carbon atoms of renewable origin.

The maleic anhydride can be obtained according to the process described in application FR 0854896 by the applicant, comprising the following stages:
a) fermentation of renewable raw materials and optionally purification in order to produce a mixture comprising at least butanol;
b) oxidation of the butanol to give maleic anhydride at a temperature generally of between 300 and 600° C. using a catalyst based on oxides of vanadium and/or of molybdenum;
c) isolation of the maleic anhydride obtained on conclusion of step b).

Various known processes can be used to graft a grafting monomer to the polypropylene. The blend can comprise the additives normally used during the processing of polyolefins at contents of between 10 ppm and 5%, such as antioxidants, for example based on substituted phenol molecules, etc., UV-protecting agents, processing agents, such as, for example, fatty amides, stearic acid and its salts, fluoropolymers (known as agents for preventing extrusion defects), amine-based defogging agents, antiblocking agents, such as silica or talc, masterbatches with dyes, nucleating agents, etc.

This can be carried out by heating the polymer at high temperature, from approximately 100° C. to approximately 300° C., in the presence or in the absence of a solvent, with or without radical generator.

Appropriate solvents or their mixtures which can be used in this reaction are benzene, toluene, xylene, chlorobenzene, cumene, etc. Carbon dioxide in its liquid and/or supercritical state is also regarded as a solvent or cosolvent in this type of process.

Appropriate radical generators which can be used comprise peroxides, preferably peroxyesters, dialkyl peroxides, hydroperoxides or peroxyketals. These peroxides are sold by Arkema under the Luperox® trademark. Mention may be made, as examples of peroxyesters, of t-butyl peroxy-2-ethylhexanoate (Luperox 26), t-butyl peroxyacetate (Luperox 7), t-amyl peroxyacetate (Luperox 555), t-butyl perbenzoate (Luperox P), t-amyl perbenzoate (Luperox TAP) and OO-t-butyl 1-(2-ethylhexyl)monoperoxycarbonate (Luperox TBEC). Mention may be made, as dialkyl peroxides, of 2,5-dimethyl-2,5-di(t-butylperoxy)hexane (Luperox 101), dicumyl peroxide (Luperox DC), α,α′-bis(t-butylperoxy)diisopropylbenzene (Luperox F40), di(t-butyl)peroxide (Luperox DI), di(t-amyl) peroxide (Luperox DTA) and 2,5-dimethyl-2,5-di(t-butylperoxy)hex-3-yne (Luperox 130). An example of hydroperoxide is t-butyl hydroperoxide (Luperox TBH70). Use may be made, for example, as peroxyketal, of 1,1-di(t-butylperoxy)-3,3,5-trimethylcyclohexane (Luperox 231), ethyl 3,3-di(t-butylperoxy)butyrate (Luperox 233) or ethyl 3,3-di(t-amylperoxy)butyrate (Luperox 533).

The grafting reaction can then be carried out according to a batch solution process or a continuous process with a melt blending device.

In the case of a batch solution grafting process, the polypropylene, dissolved in an appropriate solvent mentioned above, is brought to the reaction temperature in the presence of the monomer and of the radical generator, the reaction temperature and time being chosen to match the kinetics of decomposition of the radical generator, it being possible for the latter to be introduced continuously. Use is preferably made of a temperature ranging from 50 to 200° C. It is preferable to use the family of the peroxyesters as radical generator for the solution grafting. The treatment of the grafted polypropylene is carried out by precipitation from a nonsolvent for the latter.

The term “nonsolvent” is understood to mean an organic or nonorganic solvent or a mixture of organic or nonorganic solvents which does not make it possible to dissolve more than 10% of the grafted polymer. Mention may be made, by way of example, of water, ketones, alcohols, esters and their mixtures. Subsequent to the precipitation, the grafted polypropylene is obtained in the form of a powder or of agglomerates by filtration and drying. The grafted polypropylene can optionally be subjected to an additional “washing” step by solid/liquid extraction between itself and a nonsolvent mentioned above.

In the case of a continuous grafting process, use is made of a device for extruding molten plastics known to a person skilled in the art. Mention may be made, by way of example, of internal mixers, open mills, single-screw or counterrotating or corotating twin-screw extruders, or continuous cokneaders. The grafting device can be one of the abovementioned devices or their combination, such as, for example, a cokneader in combination with a take-up single-screw, a corotating twin-screw in combination with a gear pump, etc. In the case of an extrusion, the device is configured so as to identify a zone of melting of the polymer, a zone of blending and reaction between the entities present and a zone of pressure reduction/venting to remove the volatile compounds. These different zones can be given material form by the configuration of the screw of the device, the use of a restriction zone or the coupling together of devices. The device is also equipped with a filtration system and/or with a strand or underwater granulation system.

The polypropylene is introduced into the device, the temperature of the body of which is regulated, this temperature being chosen to match the kinetics of decomposition of the radical generator. It is preferable to use, as radical generator for the continuous grafting, the families of the dialkyl peroxides, of the hydroperoxides or of the peroxyketals. Use is preferably made of a temperature ranging from 100 to 300° C., more preferably from 200 to 280° C.

The polypropylene, the grafting monomer and the radical generator can be introduced simultaneously or separately into the extrusion device. In particular, the monomer and the radical generator can be introduced simultaneously with the polymer as main feed or separately by liquid injection along the device, together or separately from one another.

At the injection stage, the monomer and/or the radical generator can be combined with a fraction of a solvent, such as those mentioned above. The aim of this solvent fraction is to facilitate the blending between the reactive entities and also the removal of the volatile compounds during the venting stage.

At the pressure reduction/venting stage, a vacuum suited to the devolatilization of the volatile compounds and to the polypropylene is applied, it being possible for the level of vacuum to range from a few millibar to several hundred.

Finally, the grafted polypropylene is recovered at the outlet of the extrusion device in the form of granulate using a granulation device.

In the polymer modified by grafting obtained in the abovementioned way, the amount of the grafting monomer can be chosen in an appropriate way but it is preferably from 1000 ppm to 10%, better still from 6000 ppm to 50 000 ppm, relative to the weight of grafted polymer.

According to one form of the invention, grafting is carried out on a blend of ungrafted polypropylene according to the invention and of another polymer, referred to as “cografting polymer”. The blend is introduced into the extrusion device with a grafting monomer and a radical generator. The cografting polymer is different from the polypropylene according to the invention, that is to say that it does not have the same characteristics.

In particular, the cografting polymer can be a polypropylene; it is then a polypropylene with a melting point and/or a ¹⁴C content different from that/those of the polypropylene according to the invention.

However, use may be made of any type of polymer as cografting polymer. Mention may be made, as examples of cografting polymer, of elastomers, homopolymers and copolymers of polystyrene type, such as styrene-based copolymers, for example SBRs (styrene/butadiene rubbers), styrene/butadiene/styrene block copolymers (SBSs), styrene/ethylene/butadiene/styrene block copolymers (SEBSs) and styrene/isoprene/styrene block copolymers (SISs). Mention may also be made of homopolymers and copolymers of ethylene, ethylene/carboxylic acid vinyl ester copolymers, such as the ethylene/vinylacetate copolymer, ethylene/unsaturated (meth)acrylic acid ester copolymers or ethylene/unsaturated (meth)acrylic acid copolymers. Preferably, the cografting polymer is of polystyrene type or of polyolefin type.

The amount of the grafted monomer is determined by assaying the succinic functional groups by FTIR spectroscopy. The MFI or melt flow index of the grafted polymer is between 0.1 and 50 g/10 min (ASTM D 1238, 190° C., 2.16 kg), advantageously between 1.5 and 20 g/10 min.

The present invention relates to the compositions comprising ungrafted polypropylene obtained from materials of renewable origin and the compositions comprising polypropylene obtained from materials of renewable origin, said polypropylene being grafted, and also the compositions comprising at least one copolymer comprising propylene obtained from materials of renewable origin.

These compositions may comprise at least one additive for improving the properties of the final material.

These additives include antioxidants, UV-protecting agents, “processing” agents that have the role of improving the appearance of the final polymer during the processing thereof, such as fatty amides, stearic acid and its salts, ethylene bis(stearamide) or fluoropolymers, defogging agents, antiblocking agents, such as silica or talc, fillers, such as calcium carbonate, and nanofillers, for instance clays, coupling agents, such as silanes, crosslinking agents, for instance peroxides, antistatic agents, nucleating agents, pigments and dyes. These additives are generally used in contents of between 10 ppm and 100 000 ppm by weight relative to the weight of the final copolymer. The compositions may also comprise additives chosen from plasticizers, fluidizers, and flame-retardant additives, such as aluminum hydroxide or magnesium hydroxide (the latter additives may reach quantities far higher than 100 000 ppm). Some of these additives can be introduced into the composition in the form of masterbatches. The present patent application more particularly targets several families of compositions which can be used as ties or adhesives, particularly in coextrusion, especially in multilayer structures, or else as a coupling agent.

Some embodiments of compositions according to the invention are described below.

Compositions of a first type comprise:
a polymer chosen from polypropylene, a copolymer comprising propylene or a blend of these polymers, the propylene used in this polymer being at least partly obtained from materials of renewable origin, this polymer being grafted by at least one of the grafting monomers described above, advantageously the polymer does not comprise more than 5% by weight of grafting monomers;
optionally an ungrafted polymer chosen from polypropylene, a copolymer comprising propylene or a blend of these polymers, the propylene used in this polymer optionally being at least partly obtained from materials of renewable origin.

Compositions of a second type comprise:
A) from 1 to 35% by weight of a polymer chosen from polypropylene, a copolymer of propylene and of an α-olefin or a blend of these polymers, the propylene used in this polymer being at least partly obtained from materials of renewable origin, this polymer being grafted by at least one of the grafting monomers described above;
B) from 15 to 99% by weight of an ungrafted polymer chosen from polypropylene, a copolymer of propylene and of an α-olefin or a blend of these polymers;
C) from 0 to 50% of at least one modifier chosen from polyethylene, poly(1-butene), polystyrene, copolymers of ethylene with at least one monomer chosen from α-olefins, unsaturated carboxylic acids or their derivatives, these derivatives being, for example, unsaturated carboxylic acid anhydrides, esters of unsaturated carboxylic acids or vinyl esters of saturated carboxylic acids, or polymers having an elastomeric nature.

The α-olefin used in the synthesis of the propylene copolymer is advantageously ethylene or a butene such as isobutene or 1-butene, particularly the α-olefin used in the copolymers is a C₃ to C₃₀ α-olefin, having a density ranging from 0.86 to 0.960, for example chosen from ethylene, propylene, 1-butene, isobutene, hexene and octene.

Compositions of a third type comprise:
A) a blend comprising from 50 to 98% by weight of a polymer chosen from polypropylene, a copolymer of propylene and of an α-olefin or a blend of these polymers, the propylene used in this polymer being at least partly obtained from materials of renewable origin, from 2 to 50% by weight of a polymer such as, for example, a polyethylene having a density ranging from 0.86 to 0.960, and polystyrene, this blend being cografted by at least one of the grafting monomers described above;
B) optionally at least one polymer chosen from polyethylene or a copolymer of ethylene and of an α-olefin, polypropylene or a copolymer of propylene and of an α-olefin, poly(1-butene) or a copolymer of 1-butene and of an α-olefin, polystyrene, or a blend of these polymers;
C) optionally at least one modifier chosen from copolymers of ethylene with a monomer chosen from esters of unsaturated carboxylic acids or vinyl esters of saturated carboxylic acids, or polymers having an elastomeric nature.

The compositions presented above will be able to exhibit the following features.

The propylene used in the ungrafted polymer may, at least partly, be obtained from materials of renewable origin.

Advantageously, the grafted propylene polymers of compositions according to the invention do not comprise more than 5% by weight of grafting monomers.

The copolymers of ethylene with at least one ester of unsaturated carboxylic acids or at least one vinyl ester of saturated carboxylic acids will be such that:
the esters of unsaturated carboxylic acids are chosen from alkyl (meth)acrylates, the alkyl of which has from 1 to 24 carbon atoms, such as for example methyl methacrylate, ethyl acrylate, n-butyl acrylate, isobutyl acrylate and 2-ethylhexyl acrylate;
the vinyl esters of saturated carboxylic acids being chosen from vinyl acetate and vinyl propionate; included among these copolymers are, in particular, acrylate or ethylene/acrylate/maleic anhydride copolymers, ethylene/vinyl acetate copolymers, and ethylene/vinyl acetate/maleic anhydride copolymers.

The “polymers having an elastomeric nature” will in particular be those defined in the standard ASTM D412, that is to say a material which can be drawn at ambient temperature to twice its length, can be maintained thus for 5 minutes and can then, after having been released, return to its initial length to within less than 10%. The term “polymer having an elastomeric nature” is also understood to mean a polymer not having exactly the above characteristics but which can be drawn and can return substantially to its initial length.

By way of example of polymers having an elastomeric nature, mention may be made of:
EPRs (ethylene/propylene rubbers, also denoted as EPMs) and EPDMs (ethylene/propylene dienes);
styrene elastomers, such as SBRs (styrene/butadiene rubbers), styrene/butadiene/styrene block copolymers (SBSs), styrene/ethylene/butadiene/styrene block copolymers (SEBSs) and styrene/isoprene/styrene block copolymers (SISs).

In the compositions described above, when maleic anhydride is used it will be possible to use maleic anhydride comprising carbon atoms of renewable origin.

The maleic anhydride can be obtained according to the process described in application FR 0854896 by the applicant, comprising the following steps:
a) fermentation of renewable raw materials and optionally purification in order to produce a mixture comprising at least butanol;
b) oxidation of the butanol to give maleic anhydride at a temperature generally of between 300 and 600° C. using a catalyst based on oxides of vanadium and/or of molybdenum;
c) isolation of the maleic anhydride obtained on conclusion of step b).

In the compositions described above, when a vinyl ester is used, it will be possible to use a vinyl ester comprising carbon atoms of renewable origin. The vinyl esters may be obtained according to the process described in application FR 0854976 by the Applicant.

The present application also targets the uses of the polypropylenes according to the invention, in particular of the grafted polypropylenes and of the compositions comprising at least one polypropylene according to the invention.

The present application in particular targets the uses of the grafted polypropylenes according to the invention as an adhesive and the compositions comprising the grafted polypropylenes according to the invention as adhesive compositions that can be used, in particular, in coextrusion, in extrusion coating or in extrusion laminating. These adhesives exhibit adhesion to many supports such as metals, for instance aluminum or polymers, for instance polyesters, polyamides, epoxy resins, polyolefins, polymers that have barrier properties to water, to gases and to hydrocarbons such as polymers of ethylene and of saponified vinyl acetate (EVOH).

The present application also targets the uses of the compositions as adhesive compositions in a multilayer structure and also the multilayer structures thus obtained.

Multilayer structures comprising at least one adhesive composition between two supports that are preferred according to the invention are of the following type:
polypropylene/adhesive composition/EVOH;
polypropylene/adhesive composition/aluminum;
polypropylene/adhesive composition/EVOH/adhesive composition/polypropylene;
polypropylene/adhesive composition/PA;
polypropylene/adhesive composition/PA/adhesive composition/polypropylene;

the “polypropylene” used as a support in these multilayer structures is an ungrafted polypropylene;

each of these multilayer structures comprises at least one adhesive composition containing a grafted polypropylene according to the present invention comprising carbon atoms resulting from renewable raw materials.

These structures are advantageously used for manufacturing packaging, for example trays, bottles or films.

The composition according to the invention may also be used in a multilayer structure between a layer of ungrafted polypropylene and an epoxy resin/metal layer (that is to say a multilayer structure of polypropylene/adhesive composition/epoxy resin/metal type) in order to manufacture pipes for transferring fluids, for example oil or gas.

The grafted polypropylenes according to the invention may also be used as an agent for coupling compounds (that is to say that they make it possible to improve the dispersion of said compounds in the polymer) in a polymer matrix, in particular a polypropylene matrix. These compounds may be natural fibers, glass fibers, mechanically-reinforcing fillers such as for example clays, silicates, carbonates, titanates, pigments or antioxidants. It is also possible to add other compounds therein such as plasticizers or fluidizers or flame retardants such as metal hydroxides, phosphates, polyphosphates or phosphonates.

Another possible application for the copolymers according to the invention is to manufacture masterbatches using the compounds cited above or any other type of additive.

The grafted polypropylenes according to the invention may also be used as a polymer compatibilizer for manufacturing blends for example polypropylene/polyamide (PP/PA), blends of polypropylene and of EVOH or polypropylene/starch blends.

Another application of the grafted polypropylene according to the invention is the manufacture of electrical cables.

1. A propylene polymer grafted by at least one grafting monomer selected from the group consisting of unsaturated carboxylic acids, functional derivatives of unsaturated carboxylic acids, unsaturated dicarboxylic acids having 4 to 10 carbon atoms, functional derivatives of unsaturated dicarboxylic acids having 4 to 10 carbon atoms, C₁-C₈ alkyl esters of unsaturated carboxylic acids, glycidyl ester derivatives of unsaturated carboxylic acids, metal salts of unsaturated carboxylic acids, and mixtures thereof,
wherein the propylene polymer comprises an amount of carbon resulting from renewable raw materials of greater than 20% by weight relative to the total weight of carbon of the propylene polymer, the amount of carbon resulting from renewable raw materials being measured according to the standard ASTM D 6866-06.

2. The grafted propylene polymer as claimed in claim 1, wherein the amount of grafting monomer represents at most 10% by weight relative to the total weight of the polymer.

3. The propylene polymer as claimed in claim 1, wherein the propylene polymer is grafted with an unsaturated carboxylic acid or a functional derivative of this acid.

4. The propylene polymer as claimed in claim 1, wherein the propylene polymer is grafted with maleic anhydride optionally comprising carbon atoms of renewable origin.

5. A process for manufacturing a grafted propylene polymer as claimed in claim 1 comprising the following steps:
a) fermenting renewable raw materials, and optionally purifying, in order to produce an alcohol or a mixture of alcohols;
b) dehydrating the alcohol or the mixture of alcohols obtained to produce, in at least one first reactor, an alkene or a mixture of alkenes, said alkene or mixture of alkenes comprising at least propylene and, optionally purifying the mixture of alkenes in order to obtain propylene;
c) polymerizing, in at least one second reactor, the propylene, optionally in the presence of a comonomer, in order to produce a propylene polymer;
d) isolating the propylene polymer obtained at the end of step c); and
e) grafting the propylene polymer obtained at the end of step d).

6. The process for manufacturing a propylene polymer as claimed in claim 5, wherein the renewable raw materials are plant materials selected from the group consisting of sugar cane, sugar beet, maple, date palm, sugar palm, sorghum, American agave, corn, wheat, barley, soft wheat, rice, potato, cassava, sweet potato, and materials comprising cellulose or hemicellulose.

7. The process for manufacturing a propylene polymer as claimed in claim 5, wherein a purification step is carried out during step a) or during step b).

8. The process for manufacturing a propylene polymer as claimed in claim 5, wherein step a) is carried out using a microorganism chosen from Clostridium beijerinckii, Clostridium aurantibutyricum, Clostridium butylicum or a mutant thereof.

9. A composition comprising a grafted propylene polymer as claimed in claim 1.

10. The composition as claimed in claim 9, wherein the grafted propylene polymer is selected from the group consisting of a grafted propylene homopolymer, a grafted copolymer comprising propylene, and a mixture of these polymers, the composition also comprising an ungrafted polymer selected from the group consisting of polypropylene, a copolymer comprising propylene, and a mixture of these polymers.

11. A method comprising using the composition as claimed in claim 9, as an adhesive composition in coextrusion, in extrusion coating or in extrusion laminating.

12. A method comprising using the composition as claimed in claim 9, as an adhesive composition on a support selected from the group consisting of metals and polymers.

13. A multilayer structure comprising a layer of a composition as claimed in claim 9 between a layer of ungrafted polypropylene and a layer made of a material selected from the group consisting of copolymers of ethylene and saponified vinyl acetate, aluminum, polyamides, and epoxy resins.

14. A method comprising using the multilayer structure as claimed in claim 13 for manufacturing packaging.

15. The multilayer structure as claimed in claim 13, wherein the multilayer structure comprises a layer of an adhesive composition between a layer of ungrafted polypropylene and an epoxy resin/metal layer.

16. The propylene polymer as claimed in claim 1, wherein the propylene polymer comprises an amount of carbon resulting from renewable raw materials of greater than 50% by weight relative to the total weight of carbon of the propylene polymer.

17. The propylene polymer as claimed in claim 6, wherein the materials comprising cellulose or hemicellulose comprise wood, straw, or paper.

18. The composition as claimed in claim 12, wherein the polymers are selected from the group consisting of polyesters, polyamides, epoxy resins, polyolefins, and mixtures thereof.

19. A method comprising using the grafted propylene polymer as claimed in claim 1 as a coupling agent for compounds in a polymer matrix, for manufacturing masterbatches, as a compatibilizer of polymers in order to manufacture blends, or for the manufacture of electrical cables.

20. The propylene polymer as claimed in claim 1, wherein the propylene polymer comprises ¹⁴C.
